(19) United States
(12) Patent Application Publication
(10) Pub. No.: US 2014/0144406 A1
(43) Pub. Date: May 29, 2014

(54) INTERNAL COMBUSTION ENGINE

(71) Applicant: BOARD OF TRUSTEES OF MICHIGAN STATE UNIVERSITY, East Lansing, MI (US)

(72) Inventors: Harold Schock, Okemos, MI (US); Guoming Zhu, Novi, MI (US); Elisa Toulson, Brighton, MI (US); Thomas Richard Stuecken, Eagle, MI (US)

(21) Appl. No.: 14/086,168

(22) Filed: Nov. 21, 2013

Related U.S. Application Data
(60) Provisional application No. 61/730,184, filed on Nov. 27, 2012.

(51) Int. Cl. F02B 19/12

(52) U.S. Cl. CPC F02B 19/12
USPC 123/260

(57) ABSTRACT

An internal combustion engine includes a pre-chamber. In another aspect, pressure within a pre-chamber is equal to or greater than pressure within a main combustion chamber at least prior to ignition in the main combustion chamber. A further aspect provides a supplemental piston creating pressure and supplying a fuel-air mixture into a pre-chamber, and a spark or glow plug has an end located within the pre-chamber for ignition of the mixture therein. In yet another aspect, internal combustion engine control software automatically controls pressure within a turbulent jet ignition pre-chamber, controls a valve-actuator to admit a fuel-air charge into the pre-chamber, and causes an ignitor to initiate combustion in the pressurized pre-chamber.

### CROSS-REFERENCE TO RELATED APPLICATIONS

This application claims the benefit of U.S. Provisional Application Ser. No. 61/730,184, filed on Nov. 27, 2012, which is incorporated by reference herein.

### BACKGROUND AND SUMMARY

The present application generally pertains to internal combustion engines and more particularly to an internal combustion engine including pre-chamber ignition.

Various pre-chamber ignition systems have been experimented with in an effort to reduce engine emissions while simultaneously increasing fuel efficiency. Such traditional systems are discussed in E. Toulson, H. Schock and W. Attard, “A Review of Pre-Chamber Initiated Jet Ignition Combustion Systems,” SAE Technical Paper, 2010-01-2263 (Oct. 25, 2010). Further examples of conventional pre-chamber engines are U.S. Patent Publication No. 2012/0103302 entitled “Turbulent Jet Ignition Pre-Chamber Combustion System for Spark Ignition Engine” which published to Attard on May 3, 2012, U.S. Pat. No. 7,107,964 entitled “Control of Auto-Ignition Timing for Homogenous Combustion Jet Ignition Engines” which issued to Kojic et al. on Sep. 19, 2006, and U.S. Pat. No. 6,953,020 entitled “Control of Auto-Ignition Timing for Combustion in Piston Engines by PreChamber Compression Ignition” which issued to Kojic et al. on Oct. 11, 2005; all of which are incorporated by reference herein. It is noteworthy, however, that the Kojic pre-chamber piston is disadvantageously intended to solely compress the pre-chamber mixture to cause auto-ignition without a spark plug or the like. Differently, the Attard device only has fuel injected into the pre-chamber and the fuel-air mixture from the combustion chamber backfeeds into the pre-chamber thereby disadvantageously causing an unknown fuel and air ratio within the pre-chamber. Therefore, neither of the traditional Kojic nor Attard devices precisely control the pre-chamber fuel and air mixture nor do they precisely control the pressure within the pre-chamber. Accordingly, conventional pre-chamber ignition devices make it difficult to ignite lean fuel-air mixtures, especially at lower temperatures.

In accordance with the present invention, an internal combustion engine includes a pre-chamber. In another aspect, pressure within a pre-chamber is equal to or greater than pressure within a main combustion chamber at least prior to ignition in the main combustion chamber. A further aspect provides a supplemental piston creating pressure and supplying a fuel-air mixture into a pre-chamber, and a spark or glow plug has an end located within the pre-chamber for ignition of the mixture therein. In yet another aspect, internal combustion engine control software automatically controls pressure within a turbulent jet ignition pre-chamber, controls a valve-actuator to admit a fuel-air charge into the pre-chamber, causes an ignitor to initiate combustion in the pressurized pre-chamber, receives a signal corresponding to pressure in the pre-chamber, and receives a signal corresponding to such pressure in a main combustion chamber of an engine block. A method of operating an internal combustion engine in an automotive vehicle is also provided.

The internal combustion engine of the present invention is advantageous over traditional devices. For example, the present device and method precisely control a pre-chamber fuel and air mixture while also precisely controlling and causing the pre-chamber pressure to be the same as or greater than that of the main combustion chamber during at least one operating condition. This reduces if not entirely prevents backfeeding from the main chamber to the pre-chamber. Furthermore, the present device is expected to significantly improve combustion of a lean fuel-air mixture or one that is heavily diluted with exhaust gas recirculation, in the main combustion chamber, even at lower operating temperatures, which should greatly reduce undesirable NOx emissions while also significantly increasing fuel efficiency. Additional advantages and features of the present invention will become apparent when considering the following description and appended claims as well as the accompanying drawings.

### BRIEF DESCRIPTION OF THE DRAWINGS

FIG. 1 is a cross-sectional view showing an internal combustion engine of the present invention;

FIG. 2 is a perspective view showing a portion of the internal combustion engine;

FIG. 3 is an enlarged and fragmentary cross-sectional view, like that of FIG. 1, showing a turbulent jet ignition system for the internal combustion engine;

FIG. 4 is a schemmatic view showing an electrical control system for the turbulent jet ignition system of the internal combustion engine; and

FIG. 5 is a chart showing expected ignition results in different operating conditions for the internal combustion engine.

### DETAILED DESCRIPTION

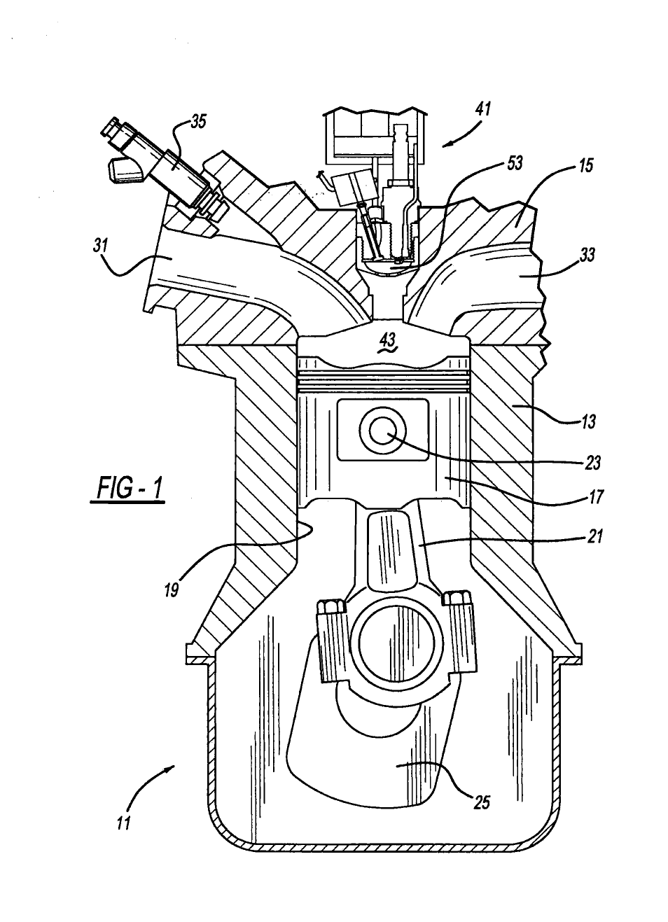

Referring to FIG. 1, an internal combustion engine 11 of an automotive vehicle includes an engine block 13 and a cylinder head 15 mounted thereto. A main driving piston 17 operably advances and retracts within a cylinder cavity 19 in order to drive a connecting rod 21 spanning between a pin 23 of piston 17 and a crank shaft 25. Furthermore, cylinder head 15 includes an intake manifold 31, an exhaust manifold 33, a direct (not shown) or port fuel injector 35 and a turbulent jet ignition system 41. A main combustion chamber 43 is located above main piston 17 partially within cylinder cavity 19 and cylinder head 15, directly below turbulent jet ignition system 41.

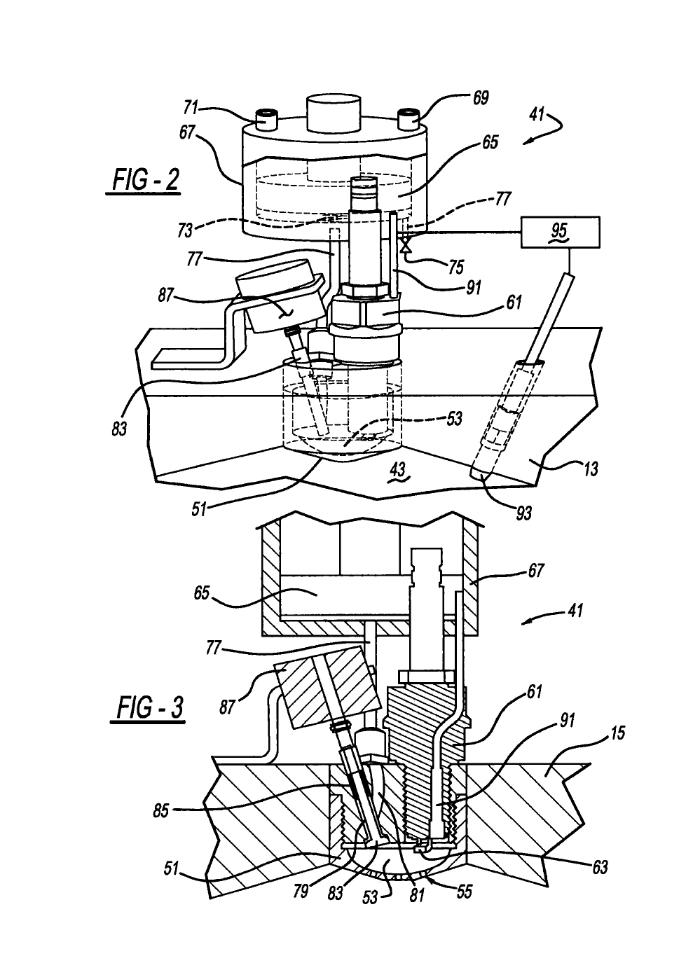

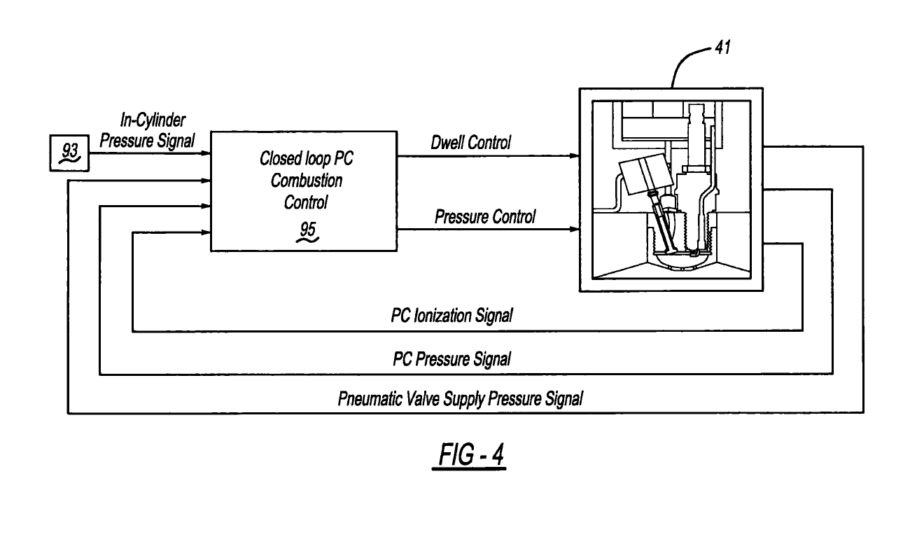

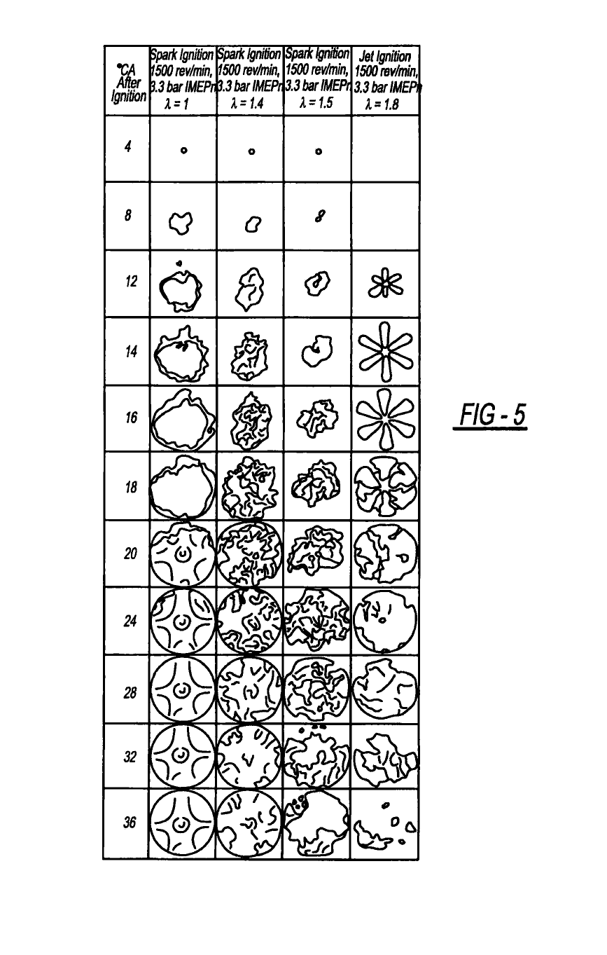

Referring now to FIGS. 2 and 3, turbulent jet ignition system 41 includes a cup-shaped housing 51 which internally defines the pre-chamber 53 therein. Housing 51 is secured to cylinder head 15 and a cap is in threaded engagement with an upper section of the housing. At least one and more preferably three to ten aperatures 55 are always open and connect pre-chamber 53 to main combustion chamber 43. Each aperature is approximately 1 mm in diameter. Turbulent jet ignition system 41 further includes an ignitor 61, such as a spark plug, glow plug or the like, which has an end 63 located within pre-chamber 53 for providing a spark or other heat ignition source for a fuel-rich, fuel-air mixture within pre-chamber 53. As used herein, “rich” means the actual fuel to air ratio is greater than stoicheometric, and “lean” is less than the stoicheometric fuel to air ratio.

Additionally, turbulent jet ignition system 41 includes a supplemental piston 65 which moves within a piston housing 67 in response to hydraulic or pneumatic fluid flowing into an inlet port 69 and exiting an outlet port 71. A biasing compression spring 73 is employed to retract piston 65 when the fluid actuating pressure is removed. Furthermore, a supply valve 75 is connected to a passageway 77 adjacent a bottom of piston housing 67 to operably allow the rich fuel-air mixture into a supplemental piston cavity for subsequent pushing of piston 65 outwardly through a conduit 77. Conduit 77 connects a bottom of supplemental piston housing 67 to an intermediate portion of a poppet valve passageway 79 via a connecting conduit 81 in the cap. A poppet valve 83 retracts to a nominal position by way of a compression spring 85 and advances when an electro-magnetically operated solenoid 87 is energized. When energized, solenoid 87 causes poppet valve 83 to open which thereby allows the piston-pressurized and rich fuel-air charge to flow from supplemental piston housing 67 into pre-chamber 53 for ignition therein.

A first pressure transducer 91 is partially located within or is otherwise accessible to pre-chamber 53 for sensing internal pressure therein and a second pressure transducer 93 is partially located within or is otherwise accessible to main combustion chamber 43 for sensing an internal pressure therein. Transducers 91 and 93 are electrically connected to an electronic controller 95, such as a programmable engine computer having a micro-processor, and non-transient computer ROM or RAM memory, capable of storing and running software including various programmed instructions.

Controller 95 has programmed instructions automatically controlling pressure within turbulent jet ignition pre-chamber 53 by causing movement of supplemental piston 65 and energization of solenoid 87 to open or close poppet valve 83. Furthermore, controller has programmed instructions which cause ignitor 61 to create a spark for igniting the rich fuel-air charge in pressurized pre-chamber 53. Moreover, controller 95 has programmed instructions receiving signals indicative of the sensed pressure in pre-chamber 53 via transducer 91 and main combustion chamber 43 via transducer 93. The controller thereafter automatically adjusts the pressure in pre-chamber 53, through piston 65 and valve 83 actuation, in a closed-loop manner for a subsequent cycle based at least on part on the sensed pressure signals. Moreover, the controller has additional programming instructions causing a fuel-air charge to be emitted into the pre-chamber at 0.9 [symbol] or richer, and the fuel-lean main fuel-air mixture to be injected into the main combustion chamber at a ratio of 1.8 [symbol] or leaner. The controller will automatically calculate and vary pre-chamber pressure, fuel quantity and ignition timing based on the sensed pressure signals, but also at least partly based on throttle positioning/signals, engine temperature, air temperature and the like.

The fuel-air mixture is mixed prior to entry into piston housing 67 which supplies pre-chamber 53. It is noteworthy that piston 65 controls the fuel-air charge pressure in pre-chamber 53 so that the pre-chamber internal pressure matches that of the main combustion chamber to reduce if not eliminate gas flow or backfeeding between the two chambers during compression of driving piston 17 in order to maintain the desired fuel-air ratio in the pre-chamber prior to spark ignition therein. Piston 65 pressurizes pre-chamber 53 on a continuous basis during the driving piston stroke of the engine. It is preferred that the internal pre-chamber pressure be the same as or up to 5% greater than that of the main combustion chamber, at least prior to ignition in the main combustion chamber. This pre-chamber pressurization methodology prevents uneven burning in the pre-chamber due to the added piston-supplied air since supplemental piston 65 is supplying a mixed fuel-air charge and not simply only air or only fuel. The pre-chamber ionization signal, along with the pre-chamber pressure signal, during the pre-chamber combustion period, is used to achieve the desired intensity level of the turbulent jet ignition system 41 by adjusting the dwell current of spark plug ignitor 61, and the pressure of the trapped fuel-air mixture in pre-chamber 53. Accordingly, solenoid 87 actuates valve 83 to an open position for emitting the rich fuel-air charge into pre-chamber 53 timed between 50-110° before TDC, and in one configuration it is preferred that the timing be approximately 90° before TDC.

The air charge in the engine main chamber is regulated using the engine throttle and intake belt timing. The fuel is also injected into the main combustion chamber 43 either through port fuel injection or direct injection. No spark plug is required for main combustion chamber since the lean fuel-air mixture in main combustion chamber 43 is ignited by the previously ignited fuel-air charge pushed through aperatures 55 from the higher pressure pre-chamber 53.

The present internal combustion engine and turbulent jet ignition system can use a variety of fuels such as gasoline, syngas, propane, natural gas and the like. The present turbulent jet ignition system has a reduced and slightly retarded ignition delay which advantageously reduces burn variability resulting from the pre-chamber ignition process and permits a wider range of operating conditions as the distributed ignition sites enable relatively small flame travel distances which promote higher burning rates. While the fuel-air mixture in the main combustion chamber can be stoichiometric, it is more advantageous to employ a leaner mixture up to 2 [symbol] or even 2.5 [symbol] (for propane and gasoline depending on the engine) thereby burning faster, improving flame propogation in lean mixtures, improving fuel efficiency, and reducing NOx emissions. FIG. 5 illustrates the expected combustion propogation of spark ignition and jet ignition at different crank angles (“° CA”) and different fuel-air ratios, in an exemplary 1500 revolutions/minute and 3.3 bar IMEPn, operating condition. More complete lean fuel-air combustion is expected in the main combustion chamber using turbulent jet ignition of the present system.

While various features of the present invention have been disclosed, it should be appreciated that other variations may be employed. For example, supplemental piston 65 is illustrated above and aligned with driving piston 17, however, alternate supplemental and driving piston configurations and positions can be employed, although various advantages of the present system may not be realized. Additionally, alternate fuel-air passageways, conduits, and ports may be provided, although some advantages may not be achieved. Additionally, it is envisioned that different types of valves, sensors and actuators may be used, but certain benefits may not be achieved. Alternately, variations in the fuel-air mixture can be used, but performance may suffer. Variations are not to be regarded as a departure from the present disclosure, and all such modifications are intended to be included within the scope and spirit of the present invention.

The invention claimed is:

1. An internal combustion engine comprising:
a pre-chamber including at least one aperture;
a main combustion chamber connected to the pre-chamber via the at least one aperture;
an ignitor operably creating heat in the pre-chamber; and
a first fuel-air mixture combusting in the pre-chamber which thereafter ignites a second leaner fuel-air mixture in the main combustion chamber through the at least one aperture;
the pre-chamber having an internal pressure equal to or greater than that of the main combustion chamber at least prior to ignition in the main combustion chamber.

2. The engine of claim 1, further comprising a pressurizing piston connected to the pre-chamber through a passageway spaced away from the at least one aperture.

3. The engine of claim 2, further comprising a driving piston moveable within the main combustion chamber and being connected to a crank shaft, the pressurizing piston causing the pre-chamber to have an internal pressure at least that of the main combustion chamber during the entire compression stroke of the driving piston in order to inhibit any residual gases in the main combustion chamber from entering the pre-chamber.

4. The engine of claim 2, further comprising:
a first valve controlling the first fuel-air mixture, which is fuel-rich, entering a piston cavity within which the pressurizing piston moves; and
an electromagnetically actuated second valve operably allowing the pressurizing piston to operably push the first rich fuel-air mixture into the pre-chamber;
the ignitor being a spark or glow plug which operably ignites the first rich fuel-air mixture in the pre-chamber.

5. The engine of claim 1, wherein the at least one aperture are one to ten apertures which are always open between the pre-chamber and main combustion chamber.

6. The engine of claim 1, wherein the fuel to air ratio of the mixture in the pre-chamber is 1-5% greater than that in the main chamber.

7. The engine of claim 1, further comprising pressure sensors associated with the pre-chamber and main combustion chamber operably sending signals to an electronic controller which uses the signals to automatically control the pressure and combustion timing of a subsequent cycle in the pre-chamber.

8. The engine of claim 1, further comprising:
a solenoid actuating a valve to admit the first fuel-air mixture, which is a rich fuel-air mixture, into the pre-chamber timed between 50-110 degrees before TDC;
a ratio of the first fuel-air mixture is equal to or less than 0.9 ( [symbol] ) in the pre-chamber; and
a ratio of the second fuel-air mixture is equal to or greater than 1.8 ( [symbol] ).

9. An internal combustion engine comprising:
(a) an engine block comprising:
a main piston cylinder;
a driving piston operably advancing and retracting in the main piston cylinder;
(b) a turbulent jet ignition system comprising:
a pre-chamber including at least one aperture always providing open access between the pre-chamber and the piston cylinder;
an ignitor having an end located within the pre-chamber;
a supplemental piston cavity connected to the pre-chamber; and
a supplemental piston operably advancing and retracting in the supplemental piston cavity.

10. The engine of claim 9, further comprising:
a first valve controlling entry of a first rich fuel-air mixture into the supplemental piston cavity within which the supplemental piston moves; and
an electromagnetically actuated second valve operably allowing the supplemental piston to push the rich fuel-air mixture into the pre-chamber;
the ignitor being a spark or glow plug which operably ignites the first fuel-air mixture in the pre-chamber.

11. The engine of claim 9, further comprising:
an automotive vehicle cylinder head including an intake manifold and an exhaust manifold, the pre-chamber being located in the cylinder head; and
an injector supplying a 1.8 [symbol] or leaner fuel-air mixture to the main piston cylinder via the intake manifold;
the turbulent jet ignition system causing ignition and essentially complete combustion of the lean or over 30% exhaust gas recirculation mixture in the main piston cylinder at 1500 revolutions per minute and 3.3 bar, and reducing NOx emissions as compared to an equivalent internal combustion engine without a turbulent jet ignition system.

12. The engine of claim 9, wherein the supplemental piston causes the internal pressure in the pre-chamber to be the same as or greater than that of a main combustion chamber in the main piston cylinder, in at least one operating condition.

13. The engine of claim 9, further comprising a rich fuel-air mixture combusting in the pre-chamber and a lean fuel-air mixture combusting in the main piston cylinder, where the combusting mixture in the pre-chamber ignites the mixture in the main piston cylinder through the at least one aperature.

14. The engine of claim 9, wherein one of hydraulic or pneumatic fluid actuates the supplemental piston, and the supplemental piston supplies a fuel-air mixture into the pre-chamber.

15. The engine of claim 9, further comprising pressure sensors associated with the pre-chamber and a combustion chamber in the main piston cylinder, the sensors sending signals to an electronic controller which uses the signals to vary pre-chamber pressure or timing for a subsequent cycle.

16. Internal combustion engine control software, stored in non-transient computer memory, the software comprising:
first programmed instructions automatically controlling pressure within a turbulent jet ignition pre-chamber;
second programmed instructions automatically controlling a valve-actuator to admit a fuel-air charge into the pre-chamber;
third programmed instructions automatically causing an ignitor to initiate combustion of the fuel-air charge in the pressurized pre-chamber;
fourth programmed instructions receiving a signal corresponding to sensed pressure in the pre-chamber;
fifth programmed instructions receiving a signal corresponding to sensed pressure in a main combustion chamber of an engine block; and
sixth programmed instructions adjusting the pressure in the pre-chamber in a closed-loop manner based at least in part on the sensed pressure signals.

17. The software of claim 16, wherein the first instructions control the pressure within the pre-chamber by causing movement of a fluid activated piston which also pushes the fuel-air charge into the pre-chamber.

18. The software of claim 17, wherein one of the instructions causes the pre-chamber to have an internal pressure at least that of the main combustion chamber during movement of a main driving piston coupled to an automotive vehicle crank shaft.

19. The software of claim 17, wherein the third instructions cause the ignitor to produce a spark in the pre-chamber.

20. The software of claim 16, further comprising additional programmed instructions causing the fuel-air charge into the pre-chamber to be 0.9 ( [symbol] ) or richer.

21. The software of claim 20, further comprising additional programmed instructions causing a main fuel-air mixture injected into the main combustion chamber to be 1.8 ( [symbol] ) or leaner.

22. A method of operating an internal combustion engine in an automotive vehicle, the method comprising:
(a) pressurizing a pre-chamber to at least that of a cylinder combustion chamber connected therewith by multiple apertures which are always open;
(b) supplying a fuel and air mixture into the pre-chamber through a single port;
(c) creating ignition heat in the pre-chamber from a spark or glow plug located at least partially within the pre-chamber to ignite the fuel and air mixture;
(d) supplying fuel and air into the combustion chamber; and
(e) igniting the fuel and air in the combustion chamber with combusted material flowing through the apertures of the pre-chamber.

23. The method of claim 22, further comprising moving a supplemental piston to pressurize the pre-chamber and moving a driving piston in response to combustion of the fuel and air in the cylinder combustion chamber.

24. The method of claim 23, further comprising injecting the fuel and air mixture into the pre-chamber by moving the supplemental piston, which is fluid actuated, and electromagnetically opening a valve between the supplemental piston and the pre-chamber.

25. The method of claim 22, further comprising essentially completely combusting the fuel and air which is a 1.8 ( [symbol] ) or leaner fuel-air mixture in the cylinder combustion chamber, and producing reduced NOx emissions as compared to an equivalent internal combustion engine without a pre-chamber ignition system.

26. The method of claim 22, further comprising:
sensing pressure in the cylinder combustion chamber; and
automatically changing at least one of: a fuel-air ratio of the mixture in the pre-chamber, a quantity of the fuel and air mixture in the pre-chamber, ignition timing in the pre-chamber, or pressure in the pre-chamber.
